(19) United States
(12) Patent Application Publication
(10) Pub. No.: US 2013/0300946 A1
(43) Pub. Date: Nov. 14, 2013

(54) VIDEO DISPLAY DEVICE AND COOLING DUCT

(71) Applicant: SONY CORPORATION, Tokyo (JP)

(72) Inventors: Yuji Manabe, Kanagawa (JP); Masahiro Saito, Tokyo (JP)

(73) Assignee: Sony Corporation, Tokyo (JP)

(21) Appl. No.: 13/886,392

(22) Filed: May 3, 2013

(30) Foreign Application Priority Data
May 10, 2012 (JP) 2012-108651

(51) Int. Cl. H04N 5/66

(52) U.S. Cl. CPC H04N 5/66
USPC 348/739; 454/284

(57) ABSTRACT

A video display device includes: a video processing unit generating and displaying video signals; an air cooling fan cooling the video processing unit by generating cooling air; a filter arranged on an intake side of the air cooling fan to remove dust; and a cooling duct to be a ventilation flue of the cooling air, having a bay portion as a concave portion formed by a protruding portion provided at an outlet end of the cooling air.

### FIELD

The present disclosure relates to a video display device performing display of videos and a cooling duct as a duct for cooling air.

### BACKGROUND

A projector device is a device of displaying videos by irradiating a liquid crystal panel (liquid crystal light bulb) with light from a light source and projecting light transmitted through the liquid crystal panel on a screen by using a projection lens.

In such projector device, the liquid crystal panel and various optical components reach a high temperature by the heat of the light source. Accordingly, cooling is performed, for example, by taking outside air into a device casing by using a fan.

In the method of performing cooling by taking outside air into the casing by using the fan, dust is also taken at the same time as taking outside air, therefore, dust may adhere to the liquid crystal panel and various optical components.

When dust is taken, the dust blocks transmitting light of the liquid crystal panel or makes the light reflect diffusely, and stains or blots may occur on an image. Accordingly, a technology of providing a dustproof filter for removing dust is proposed.

Examples of the related art include JP-A-2008-268626, JP-A-2007-256899 and JP-A-2011-123177.

### SUMMARY

As digital screening in move theaters is becoming popular in recent years, a problem in video quality (a phenomenon that luminance is reduced with time at the time of projecting) becomes obvious in a projector device for projecting digital movies.

As a result of investigation into materials which have adhered to and have been accumulated on the liquid crystal panel and the various optical components, it has been found that a cooking oil component assumed to be caused by oil mist generated in a cooking space in the movie theater is included in addition to the dust.

As the oil mist is finer than the density of the dustproof filter, the oil mist passes through the dustproof filter and collides against the liquid crystal panel and various optical components positioned on a downstream side of the air flow, then, the mist adheres to and is accumulated on them. The oil mist accumulated once has a nature of taking and holding dust, which may induce further accumulation of dust.

In order to protect device components from oil mist floating in the air, a means of mounting a thick air filter can be considered for prevention, however, it is difficult to remove all the floating oil mist, and further, the thick filter is a factor of cost increase.

In view of the above, it is desirable to provide a video display device and a cooling duct capable of removing oil mist and dust efficiently.

An embodiment of the present disclosure is directed to a video display device. The video display device includes a video processing unit, an air cooling fan, a filter, and a cooling duct. The video processing unit generates and displays video signals. An air cooling fan cools the video processing unit by generating cooling air. A filter is arranged on an intake side of the air cooling fan to remove dust. A cooling duct is a ventilation flue of the cooling air and has a bay portion as a concave portion formed by a protruding portion provided at an outlet end of the cooling air.

It is possible to remove oil mist and dust efficiently.

### BRIEF DESCRIPTION OF THE DRAWINGS

FIG. 1 is a view showing a structure example of a video display device;

FIG. 2 is a view showing an example of the entire structure of the video display device;

FIG. 3 is a view showing a cooling structure;

FIG. 4 is a view showing a cooling structure;

FIG. 5 is a view showing a structure example of a cooling duct;

FIG. 6 is a view showing a structure example of a cooling duct;

FIG. 7 is a view showing a structure example of a cooling duct;

FIG. 8 is a view showing a structure example of a cooling duct;

FIG. 9 is a view showing a structure example of a cooling duct;

FIG. 10 is a view showing a structure example of a cooling duct;

FIG. 11 is a view showing a structure example of a cooling duct;

FIG. 12 is a view showing a structure example of a cooling duct;

FIG. 13 is a view showing a structure example of a cooling duct; and

FIG. 14 is a view showing a structure example of an optical unit in a reflective LCD projector.

### DETAILED DESCRIPTION

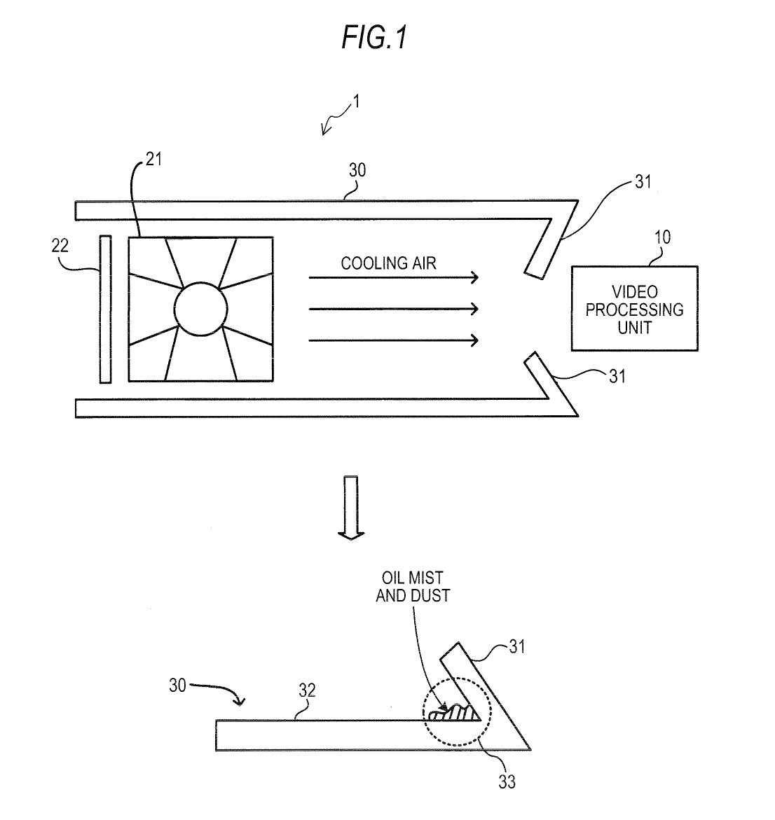

Hereinafter, an embodiment of the present disclosure will be explained with reference to the drawings. FIG. 1 is a view showing a structure example of a video display device. A video display device 1 is a device performing projection-type video display, including a video processing 10, an air cooling fan 21, a filter 22 and a cooling duct 30.

The video processing unit 10 is a functional unit generating and displaying video signals, which corresponds to, for example, an optical system in the device. The air cooling fan 21 cools the video processing unit 10 by generating cooling air.

The filter 22 is arranged on an intake side of the air cooling fan 21 to remove dust. The cooling duct 30 is a ventilation flue of cooling air, having a bay portion 33 as a concave portion formed by a protruding portion 31 provided at an outlet end of cooling air.

Here, oil mist floating in the air and dust which has not been completely removed by the filter are gathered along a ventilation wall 32 of the cooling duct 30 by cooling air generated by the air cooling fan 21.

The cooling duct 30 shown in FIG. 1 has the concave bay portion 33 formed by the protruding portion 31 provided at the outlet end of cooling air and the ventilation wall 32, and oil mist and dust gathered along the ventilation wall 32 are accumulated and captured in the bay portion 33.

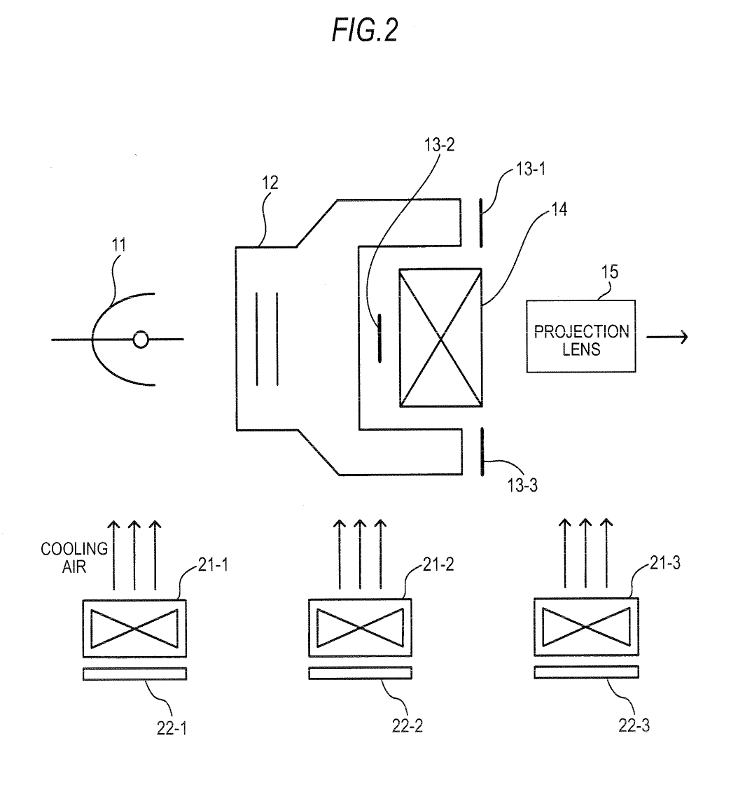

Next, the entire structure of the video display device 1 will be explained. FIG. 2 is a view showing an example of the entire structure of the video display device. The video display device 1 includes a light source 11, an optical unit 12, a liquid crystal panels 13-1 to 13-3, a color synthesis prism (cross dichroic prism) 14 and a projection lens 15 as the video processing unit 10 (optical system).

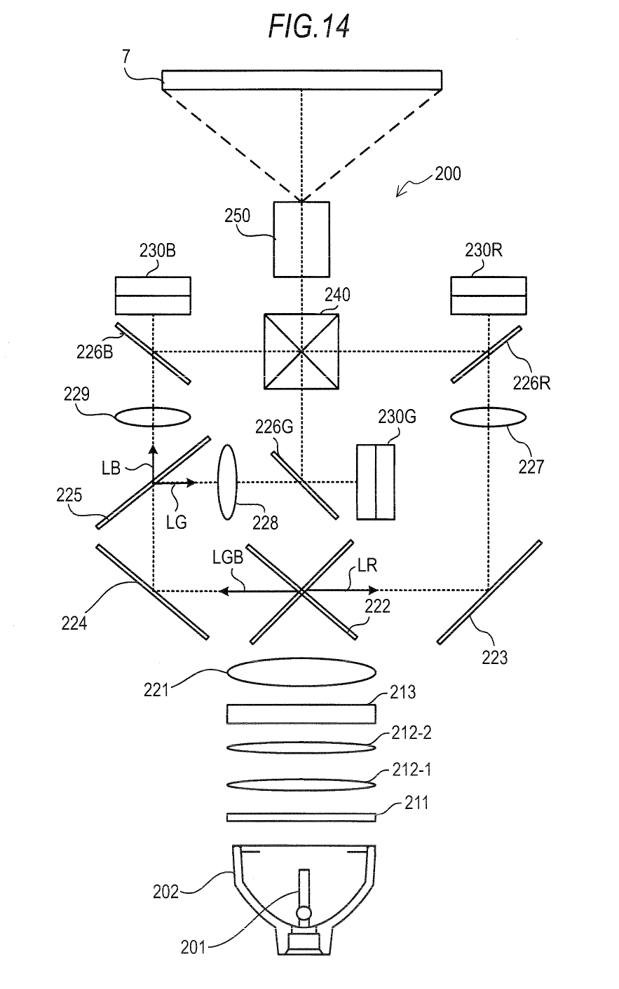

The light source 11 emits white light and the optical unit 12 separates white light into R (red), G (green) and B (blue). The liquid crystal panels 13-1 to 13-3 generate videos by respective light of R, G and B. The color synthetic prism 14 synthesizes RGB after generating the videos. The projection lens 15 projects emitted light from the color synthetic prism 14 on a screen. The specific structure and operation of the optical system will be explained later with reference to FIG. 14.

Additionally, air cooling fans 21-1 to 21-3 are arranged in the vicinity of the above respective components. The air cooling fans 21-1 to 21-3 takes air from the outside and generates cooling air. The air cooling fan 21-1 cools the light source 11, the air cooling fan 21-2 cools the optical unit 12 and air cooling fan 21-3 cools the liquid crystal panels 13-1 to 13-3.

Though each of the cooling fans is arranged with respect to each of units in the drawing, however, a plurality of fans are arranged with respect to each unit according to need (for example, as a large number of components are included in the optical unit 12, a plurality of air cooling fans are normally arranged with respect to the optical unit 12).

The filters 22-1 to 22-3 are arranged on an upstream side (intake side) of ventilation flues of the air cooling fans 21-1 to 21-3 to remove dust by filtering intake air of the air cooling fans 21-1 to 21-3. The cooling duct as a duct for guiding cooling air from the air cooling fans 21-1 to 21-3 to cooling targets is provided in the device, though not shown.

The cooling duct according to the embodiment of the present disclosure has a structure in which the concave bay portion 33 (concave portion) bending in a downstream side of cooling air is provided to prevent oil mist and dust as described later, which can prevent floating oil mist and dust from adhering to optical components in the device.

Here, it is preferable to use an axial-flow fan as the air cooling fan 21. The oil floating in the air can be cut to some degree by the filter 22 first at the time of entering the device, however, vaporized oil passed through the filter 22 is liquefied by the air cooling fan 21 which cools air.

At this time, it is possible to suppress the proportion of liquefaction when using the axial-flow fan as compared with a case of using a sirocco fan. It is because the sirocco fan has larger a fan housing and thus has more collision surfaces.

Additionally, when using the axial-flow cooling fan 21, the air flow of cooling air is radial. Accordingly, oil mist and dust are localized to a peripheral portion of an axial direction rather than a central portion of the axial direction due to centrifugal force.

Accordingly, the oil mist and dust localized to the peripheral portion of the axial direction are allowed to collide against and accumulated in the protruding portion 31, thereby capturing the oil mist and dust in the bay portion 33 efficiently. Then, the air with a relatively low concentration of oil mist in the central portion of the axial direction can be transmitted to the video processing unit (cooled portion) 10 positioned on the downstream side of an opening of the duct outlet.

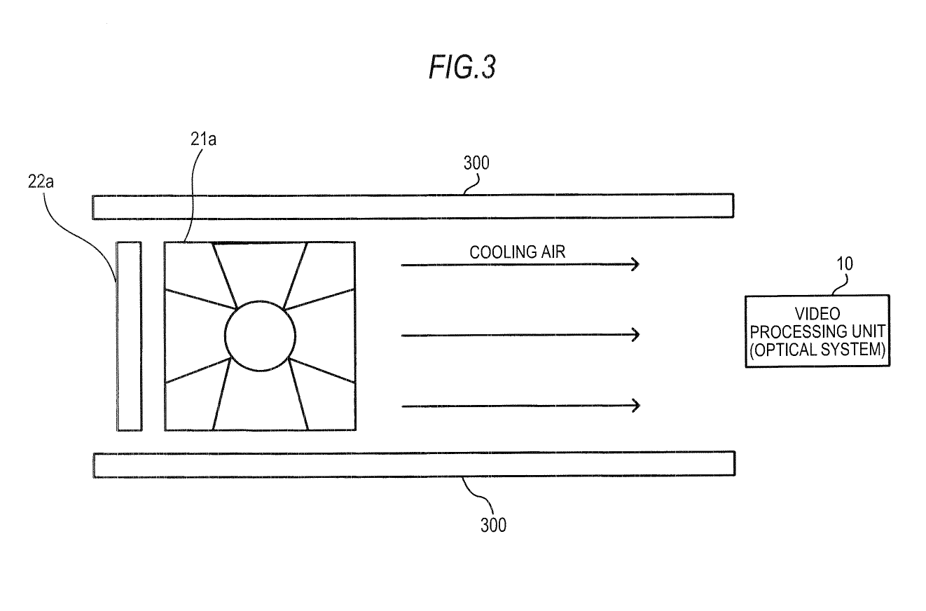

Next, the cooling duct 30 will be explained. First, a related-art cooling duct will be explained. FIG. 3 is a view showing a cooling structure. A cooling duct 300 in related art not having a removing function of oil mist and dust is shown.

The oil floating in the air can be cut to some degree by a filter 22a first at the time of entering the device, however, vaporized oil passed through the filter 22a is liquefied by an air cooling fan 21a which cools air. The liquefied oil is spattered inside the cooling duct 300 by cooling air and adheres to respective components of the video processing unit (optical system) 10 positioned on the downstream side.

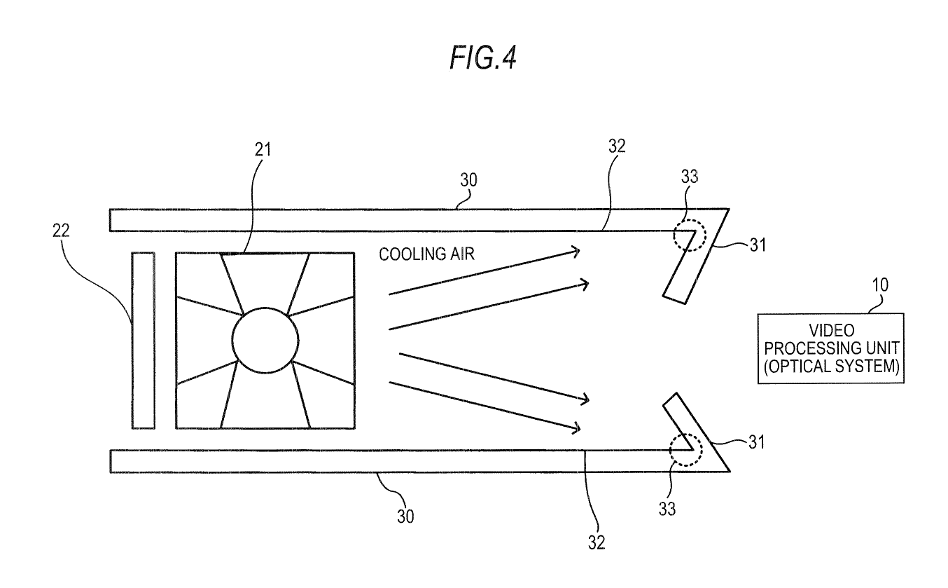

Next, the operation of the cooling duct 30 according to the embodiment of the present disclosure will be explained. FIG. 4 is a view showing a cooling structure. In the cooling duct 30, the protruding portion (turn-down portion) 31 is provided at the duct outlet, and the bay portion (pocket) 33 bending in the downstream direction is provided, which is formed by the protruding portion 31 and the ventilation wall 32.

The oil mist gathered due to the centrifugal force of the air-cooling fan 21 and dust gathered by the centrifugal force of the air-cooling fan 21 and has not been completely removed by the filter 22 can be captured by the bay portion 33 provided at the duct outlet. Accordingly, it is possible to prevent the oil mist or air with a high concentration of dust from flowing to the downstream direction where the video processing unit (optical system) 10 is positioned.

As described above, in the cooling mechanism of the video display device 1, the air taken by the air cooling fan (axial-flow fan) 21 from an air intake port is passed through the filter 22 first, thereby removing a great deal of dust.

Then, oil mist and dust which has not been completely removed by the filter 22 are passed in the cooling duct 30 with the cooling air, however, the oil mist and dust are gathered along the ventilation wall 32 (outer periphery) due to centrifugal separation of the air cooling fan 21.

Subsequently, the oil mist and duct gathered along the ventilation wall 32 collides against the bay portion 33 at the duct outlet, accumulated and captured inside the bay portion 33. Accordingly, it is possible to efficiently suppress the oil mist and dust flowing in the downstream side where the optical system is positioned.

Next, structure examples of the cooling duct 30 will be explained. FIG. 5 to FIG. 13 are views showing structure examples of the cooling duct 30. In the cooling duct 30 of FIG. 5, the protruding portion 31 is formed at an outlet (a duct outlet) end of the ventilation flue so that one end is connected to the ventilation wall 32 at an acute angle and the other end is directed to the upstream side of cooling air. The bay portion 33 is formed at a concave portion formed by the protruding portion 31 and the ventilation wall 32.

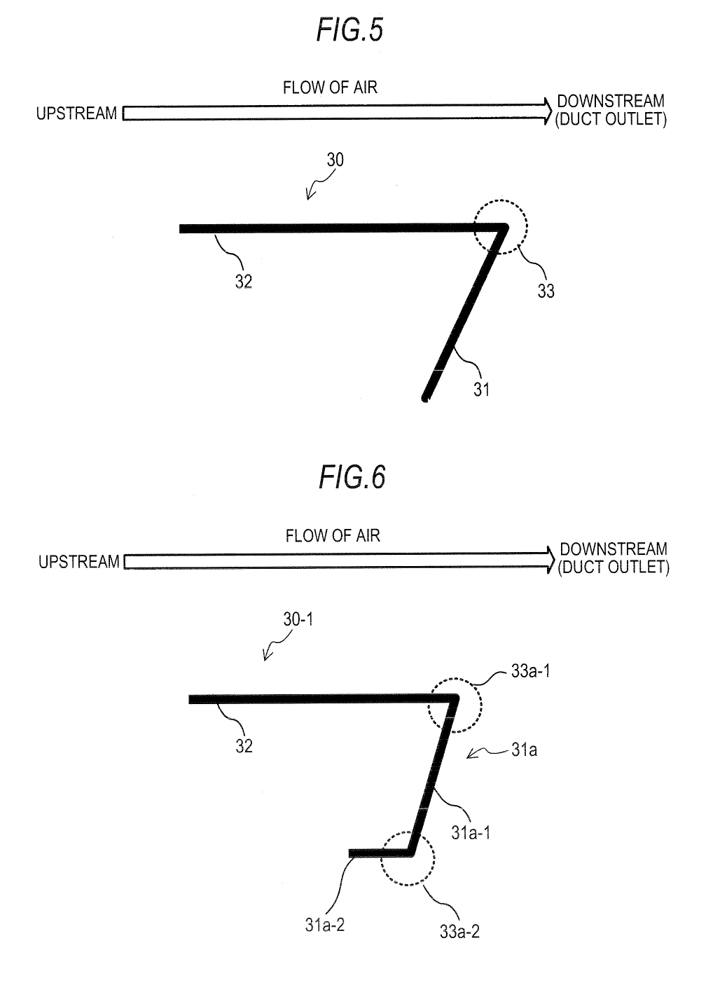

In a cooling duct 30-1 of FIG. 6, a protruding portion 31a includes protruding members 31a-1 and 31a-2. The protruding member 31a-1 is a member formed so that one end is connected to the ventilation wall 32 at an acute angle and the other end is directed to the upstream side of cooling air. The protruding member 31a-2 is a member formed so that one end of the member itself is connected to the other end of the protruding member 31a-1 and the other end of the member itself is provided in parallel to the ventilation wall 32 toward the upstream side of cooling air.

Additionally, a bay portion 33a-1 is formed between the protruding member 31a-1 and the ventilation wall 32 and bay portion 33a-2 is formed between the protruding member 31a-1 and a protruding member 31a-2.

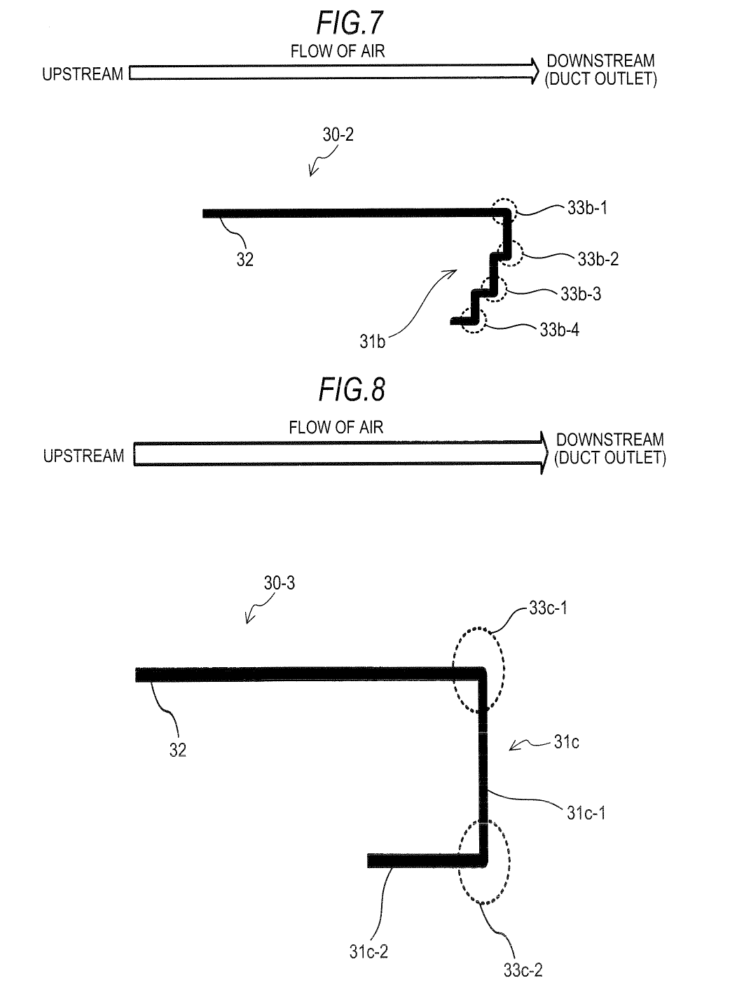

In a cooling duct 30-2 of FIG. 7, a protruding portion 31b is formed so that one end is connected at right angles to the ventilation wall 32 and the other end is directed to the upstream side of cooling air, in which a member surface between one end and the other end is formed in a staircase pattern. Additionally, bay portions 33b-1 to 33b-4 are formed at concave portions in the member surface of the protruding portion 31b formed in the staircase pattern.

In a cooling duct 30-3 of FIG. 8, a protruding portion 31c includes protruding members 31c-1 and 31c-2. The protruding member 31c-1 is a member formed so that one end is connected at right angles to the ventilation wall 32 and the other end is perpendicularly directed to the ventilation wall 32. The protruding member 31c-2 is a member formed so that one end of the member itself is connected to the other end of the protruding member 31c-1 and the other end of the member itself is provided in parallel to the ventilation wall 32 toward the upstream side of cooling air.

Additionally, a bay portion 33c-11s formed between the protruding member 31c-1 and the ventilation wall 32. A bay portion 33c-2 is formed between the protruding member 31c-1 and the protruding member 31c-2.

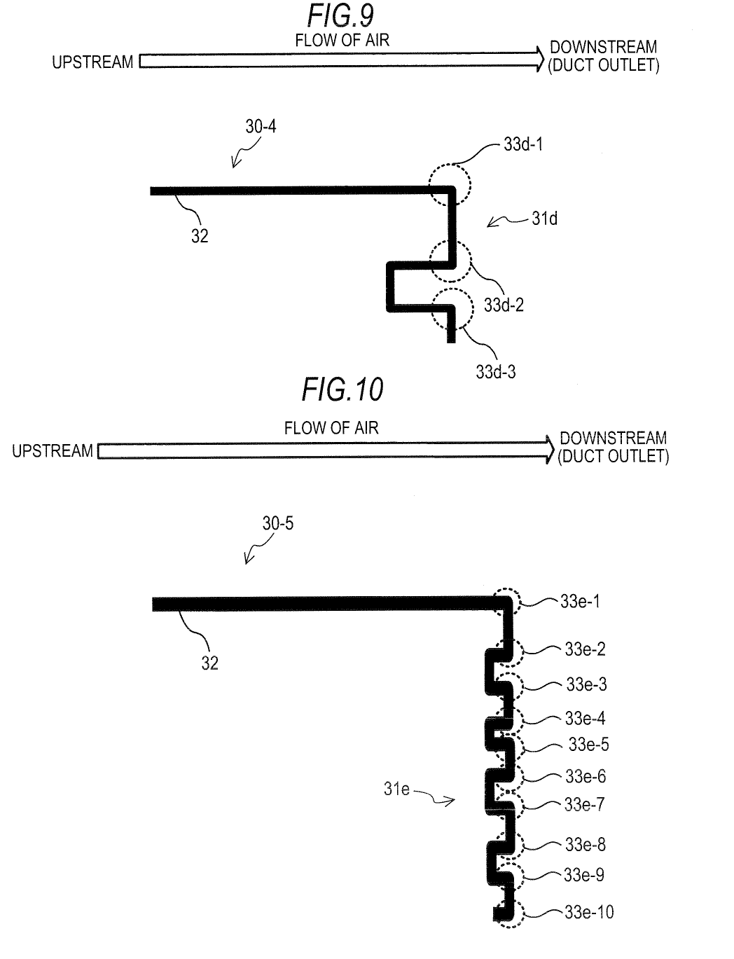

In a cooling duct 30-4 of FIG. 9, a protruding portion 31d is formed so that one end is connected at right angles to the ventilation wall 32 and a single convex surface is formed in a member surface between one end and the other end toward the upstream side of cooling air.

Additionally, a bay portion 33d-1 is formed between the protruding portion 31d and the ventilation wall 32, and bay portions 33d-2 and 33d-3 are formed at concave portions in the member surface of the protruding portion 31d.

In a cooling duct 30-5 of FIG. 10, a protruding portion 31e is formed so that one end is connected at right angles to the ventilation wall 32 and plural concavo-convex surfaces are formed in a member surface between one end and the other end. Additionally, a bay portion 33e-1 is formed between the protruding portion 31e and the ventilation wall 32 and bay portions 33e-2 to 33e-10 are formed at concave portions in the member surface of the protruding portion 31e.

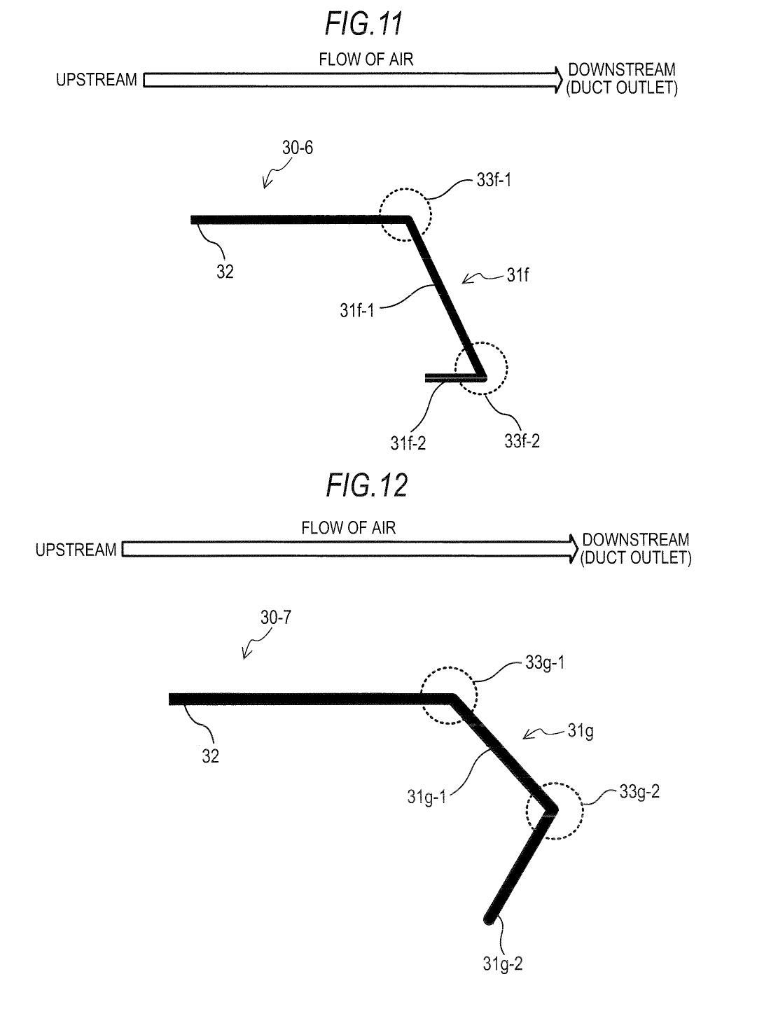

In a cooling duct 30-6 of FIG. 11, a protruding portion 31f includes protruding members 31f-1 and 31f-2. The protruding member 31f-1 is a member formed so that one end is connected to the ventilation wall 32 at an obtuse angle and the other end is directed to the downstream side of cooling air.

The protruding member 31f-2 is a member formed so that one end of the member itself is connected to the other end of the protruding member 31f-1 and the other end of the member itself is provided in parallel with the ventilation wall 32 toward the upstream side of cooling air. Additionally, a bay portion 33f-1 is formed between the protruding member 31f-1 and the ventilation wall 32. The bay portion 33f-2 is formed between the protruding member 31f-1 and the protruding member 31f-2.

In a cooling duct 30-7 of FIG. 12, a protruding portion 31g includes protruding members 31g-1 and 31g-2. The protruding member 31g-1 is a member formed so that one end is connected to the ventilation wall 32 at an obtuse angle and the other end is directed to the downstream side of cooling air. The protruding member 31g-2 is a member formed so that one end of the member itself is connected to the other end of the protruding member 31g-1 at an angle larger than a right angle and the other end of the member itself is directed to the upstream side of cooling air.

The bay portion 33g-1 is formed between the protruding member 31g-1 and the ventilation wall 32. The bay portion 33g-2 is formed between the protruding member 31g-1 and the protruding member 31g-2.

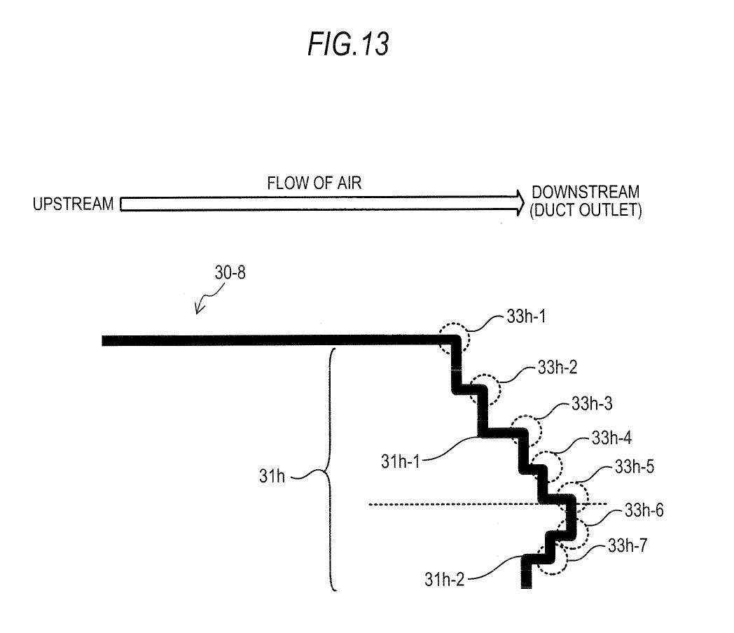

In a cooling duct 30-8 of FIG. 13, a protruding portion 31h includes protruding members 31h-1 and 31h-2. The protruding member 31h-1 is a member formed so that one end is connected at right angles to the ventilation wall 32 and the other end is directed to the downstream side of cooling air, in which a member surface between one end and the other is formed in a staircase pattern.

The protruding portion 31h-2 is a member formed so that one end of the member itself is connected at right angles to the other end of the protruding member 31h-1 and the member surface between one end of the member itself and the other end is formed in a staircase pattern. Additionally, by portions 33h-1 to 33h-7 are formed at concave portions of the member surface formed in the staircase pattern.

The above structures of the cooling ducts are examples and other structures can be applied. Though the protruding portion 31 is formed in a straight-line shape, the protruding portion 31 may be formed in a curved-line shape. When bellows-shape concavo-convex surfaces are provided in the protruding portions 31b, 31e and 31h as shown in FIG. 7, FIG. 10 and FIG. 13, the specific surface area can be increased, which can accumulate oil mist and dust more effectively.

Next, functions which can be added to the cooling duct 30 will be explained. The cooling duct 30 can be formed as a disposable-type duct. In this case, maintenance is easy. It is also possible to provide a mechanism for showing the degree of adhesion of oil mist and dust at the bay portion 33 of the cooling duct 30. In this case, the time for exchange can be easily recognized.

It is also possible to form the cooling duct 30 to have a surface shape to which oil mist easily adheres (promotion of liquefaction; devices for allowing oil mist to be easily developed as grease spots and for reducing surface tension of oil mist). It is further possible to form the cooling duct 30 to have a shape in which cleaning is easy and the air flow can be positively gathered to the bay portion 33.

It is further possible to provide a mechanism for easily collecting oil captured in the bay portion 33. For example, a device (electric dust collector) for attracting oil mist to be captured by using electric charges having a polarity reverse to the oil mist may be provided at the duct outlet.

Next, a structure example of an optical unit in a reflective LCD (Liquid Crystal Display) projector will be explained as a structure example of the video processing unit 10 of the video display device 1. FIG. 14 is a view showing a structure example of an optical unit in the reflective LCD projector.

In a reflective LCD projector 200, a light source 201 is arranged at a focus position of the reflector 202, and white light emitted from the light source 201 is reflected in the reflector 202 to generate approximately parallel light. An UV (Ultraviolet/Infrared Rays) cut filter 211 receives the approximately parallel light and blocks transmission of ultraviolet and infrared rays. The reflector 202 may have an elliptic shape in addition to a parabolic shape.

Fly-eye lenses 212-1 and 212-2 uniformize illuminance of light and a PS converter (polarization conversion device) 213 aligns polarization directions of random polarization of P-polarization/S-polarization. A main condenser lens 221 collects white illumination light uniformized by aligning polarization directions by the PS converter 213.

A dichroic mirror 222 separates light into a light LR in a red wavelength region and a light LGB in green and blue wavelength region. The dichroic mirror is also used in both separation methods of red color separation and blue color separation. A reflective mirror 223 reflects the red light LR separated by the dichroic mirror 222.

The reflective mirror 224 reflects green and blue light LGB separated by the dichroic mirror 222. A dichroic mirror 225 reflects only light in a green wavelength region and transmits light in a blue wavelength region in the light LGB reflected by the reflective mirror 224.

A polarizing plate 226R transmits the red light LR as the P-polarization light reflected by the reflective mirror 223 to allow the red light to be incident on a reflective liquid crystal panel 230R, and reflects the red light which has been spatially modulated in the reflective liquid crystal panel 230R and converted into the S-polarization light to allow the red light to be incident on a color synthesis prism 240. It is also preferable that polarizing plates are arranged on respective incident surfaces of RGB of the color synthesis prism 240.

In a SSS system, green light is directly incident on the color synthesis prism 240. In a SPS system, a ½ wavelength plate is arranged on an incident side of the color synthesis prism 240, and green light is incident on the color synthesis prism 240 in the P-polarization.

A polarizing plate 226G transmits the green light LG as the P-polarization light reflected by the dichroic mirror 225 to allow the green light to be incident on a reflective liquid crystal panel 230G, and reflects the green light which has been spatially modulated in the reflective liquid crystal panel 230G and converted into the S-polarization light to allow the green light to be incident on the color synthesis prism 240.

A polarizing plate 226B transmits the blue light LB as the P-polarization light transmitted through the dichroic mirror 225 to allow the blue light to be incident on a reflective liquid crystal panel 230B, and reflects the blue light which has been spatially modulated in the reflective liquid crystal panel 230B and converted into the S-polarization light to allow the blue light to be incident on the color synthesis prism 240. Optical lenses 227 to 229 are arranged on the incident side of respective polarizing plates 226R, 226G and 226B (polarizing plates may be arranged also between the optical lens 228 and the polarizing plate 226G.)

Here, white light outputted from the light source 201 is uniformized in luminance by the fly-eye lenses 212-1 and 212-2 and is aligned to the given polarization by the PS converter 213. After the output light is oriented so as to illuminate the reflective liquid crystal panels 230R, 230G and 230B by the main condenser lens 221, the light is separated into light in three wavelength bands by the dichroic mirrors 222 and 225 as color separation mirrors or other components.

The separated lights of respective colors are incident on reflective polarizing plates, in which only light in a certain polarization direction is selected by the polarizing plates 226R, 226G and 226B and incident on the reflective liquid crystal panels 230R, 230G and 230B. Lights of RGB are incident on respective reflective liquid crystal panels 230R, 230G and 230B.

Video signals of colors corresponding to incident light are applied to the reflective liquid crystal panels 230R, 230G and 230B, and the reflective liquid crystal panels 230R, 230G and 230B rotate the polarizing direction of incident lights in accordance with the video signals to output modulated lights. The modulated lights outputted from the liquid crystal panels are incident again on the polarizing plates 226R, 226G and 226B.

Only a polarization component rotated by 90 degrees is selected from each polarization light incident on the polarizing plates 226R, 226G and 226B to be incident on the color synthesis prism 240. The lights of respective colors modulated by three reflective liquid crystal panels are synthesized in the same direction in the color synthesis prism 240 and outputted. The emitted synthesized light from the color synthesis prism 240 is outputted and projected on a screen 7 by a projection lens 250.

Though the structure of the reflective LCD projector has been explained as the example of the video processing unit 10, a transmissive LCD projector may be also applied.

As explained above, the video display device 1 has the structure of including the cooling duct 30 having the bay portion 30 as the concave portion formed by the protruding portion 31 provided at the outlet end of cooling air. In the structure, the axial-flow air cooling fan 21 is used.

According to the above structure, the flow of cooling air is not uniform and will be biased due to centrifugal force. As the bay portion 33 is provided at the cooling duct 30, oil mist and duct are accumulated in the bay portion 33 with respect to the direction of the flow. Accordingly, it is possible to remove oil mist and dust effectively and prevent the oil mist and dust from adhering to internal components of the device.

The present disclosure may apply the following configurations.

(1) A video display device including

a video processing unit generating and displaying video signals,

an air cooling fan cooling the video processing unit by generating cooling air,

a filter arranged on an intake side of the air cooling fan to remove dust, and

a cooling duct to be a ventilation flue of the cooling air, having a bay portion as a concave portion formed by a protruding portion provided at an outlet end of the cooling air.

(2) The video display device described in the above (1),

in which the bay portion captures oil mist and dust which has not been completely removed gathered along a ventilation wall by the cooling air.

(3) The video display device described in the above (1) or (2),

in which the protruding portion is formed so that one end is connected to the ventilation wall at an acute angle and the other end is directed to an upstream side of the cooling air, and

the bay portion is formed between the protruding portion and the ventilation wall.

(4) The video display device described in any of the above (1) to (3),

in which the protruding portion includes a first protruding member formed so that first one end is connected to the ventilation wall at an acute angle and the first other end is directed to the upstream side of the cooling air and a second protruding member formed in parallel to the ventilation wall so that second one end is connected to the first other end and the second other end is directed to the upstream side of the cooling air, and

the bay portions are formed between the first protruding member and the ventilation wall, and between the first and second protruding members.

(5) The video display device described in any of the above (1) to (4),

in which the protruding portion is formed so that one end is connected at right angles to the ventilation wall and a member surface between one end and the other end is formed in a staircase pattern, and

the bay portions are formed at concave portions in the member surface formed in the staircase pattern.

(6) The video display device described in any of the above (1) to (5),

in which the protruding portion includes a first protruding member formed so that first one end is connected at right angles to the ventilation wall and the first other end is perpendicularly directed to the ventilation wall and a second protruding member formed in parallel to the ventilation wall so that second one end is connected to the first other end and the second other end is directed to the upstream side of the cooling air, and

the bay portions are formed between the first protruding member and the ventilation wall, and between the first and second protruding members.

(7) The video display device described in any of the above (1) to (6),

in which the protruding portion is formed so that one end is connected at right angles to the ventilation wall and a single convex surface is formed toward the upstream side of cooling air in a member surface between one end and the other end, and

the bay portions are formed between the protruding portion and the ventilation wall and concave portions in the member surface.

(8) The video display device described in any of the above (1) to (7),

in which the protruding portion is formed so that one end is connected at right angles to the ventilation wall and plural concavo-convex surfaces are formed in a member surface between one end and the other end, and

the bay portions are formed between the protruding portion and the ventilation wall and concave portions in the member surface.

(9) The video display device described in any of the above (1) to (8),

in which the protruding portion includes a first protruding member formed so that first one end is connected to the ventilation wall at an obtuse angle and the first other end is directed to a downstream side of the cooling air and a second protruding member formed in parallel to the ventilation wall so that second one end is connected to the first other end and the second other end is directed to the upstream side of the cooling air, and

the bay portions are formed between the first protruding portion and the ventilation wall, and between the first and second protruding members.

(10) The video display device described in any of the above (1) to (9),

in which the protruding portion includes a first protruding member formed so that first one end is connected to the ventilation wall at an obtuse angle and the first other end is directed to the downstream side of the cooling air and a second protruding member formed not in parallel with the ventilation wall so that second one end is connected to the first other end at an angle larger than a right angle and the second other end is directed to the upstream side of the cooling air, and

the bay portions are formed between the first protruding member and the ventilation wall, and between the first and second protruding members.

(11) The video display device described in any of the above (1) to (10),

in which the protruding portion includes a first protruding member formed so that first one end is connected at right angles to the ventilation wall and the first other end is directed to the downstream side of the cooling air, in which a member surface between first one end and the first other is formed in a staircase pattern, and a second protruding member formed so that second one end is connected at right angles to the first other end and a member surface between second one end and the second other end is formed in a staircase pattern, and

the bay portions are formed at concave portions in the member surface formed in the staircase pattern.

(12) The video display device described in any of the above (1) to (11),

in which the air cooling fan is an axial-flow fan.

(13) A cooling duct to be a ventilation flue of cooling air, including

a protruding portion provided at an outlet end of the cooling air, and

a bay portion as a concave portion formed by the protruding portion, capturing oil mist and dust gathered along a ventilation wall by the cooling air.

In the above embodiment, various modifications may occur within a scope not departing from the gist of the present disclosure.

Further in the above embodiment, a great deal of modifications and alternations may occur to those skilled in the art, and the embodiment is not limited to the explained accurate structures and application examples.

The present disclosure contains subject matter related to that disclosed in Japanese Priority Patent Application JP 2012-108651 filed in the Japan Patent Office on May 10, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A video display device comprising:
a video processing unit generating and displaying video signals;
an air cooling fan cooling the video processing unit by generating cooling air;
a filter arranged on an intake side of the air cooling fan to remove dust; and
a cooling duct to be a ventilation flue of the cooling air, having a bay portion as a concave portion formed by a protruding portion provided at an outlet end of the cooling air.

2. The video display device according to claim 1,
wherein the bay portion captures oil mist and dust which has not been completely removed gathered along a ventilation wall by the cooling air.

3. The video display device according to claim 1,
wherein the protruding portion is formed so that one end is connected to the ventilation wall at an acute angle and the other end is directed to an upstream side of the cooling air, and
the bay portion is formed between the protruding portion and the ventilation wall.

4. The video display device according to claim 1,
wherein the protruding portion includes a first protruding member formed so that first one end is connected to the ventilation wall at an acute angle and the first other end is directed to the upstream side of the cooling air and a second protruding member formed in parallel to the ventilation wall so that second one end is connected to the first other end and the second other end is directed to the upstream side of the cooling air, and
the bay portions are formed between the first protruding member and the ventilation wall, and between the first and second protruding members.

5. The video display device according to claim 1,
wherein the protruding portion is formed so that one end is connected at right angles to the ventilation wall and a member surface between one end and the other end is formed in a staircase pattern, and
the bay portions are formed at concave portions in the member surface formed in the staircase pattern.

6. The video display device according to claim 1,
wherein the protruding portion includes a first protruding member formed so that first one end is connected at right angles to the ventilation wall and the first other end is perpendicularly directed to the ventilation wall and a second protruding member formed in parallel to the ventilation wall so that second one end is connected to the first other end and the second other end is directed to the upstream side of the cooling air, and
the bay portions are formed between the first protruding member and the ventilation wall, and between the first and second protruding members.

7. The video display device according to claim 1,
wherein the protruding portion is formed so that one end is connected at right angles to the ventilation wall and a single convex surface is formed toward the upstream side of cooling air in a member surface between one end and the other end, and
the bay portions are formed between the protruding portion and the ventilation wall and concave portions in the member surface.

8. The video display device according to claim 1,
wherein the protruding portion is formed so that one end is connected at right angles to the ventilation wall and plural concavo-convex surfaces are formed in a member surface between one end and the other end, and
the bay portions are formed between the protruding portion and the ventilation wall and concave portions in the member surface.

9. The video display device according to claim 1,
wherein the protruding portion includes a first protruding member formed so that first one end is connected to the ventilation wall at an obtuse angle and the first other end is directed to a downstream side of the cooling air and a second protruding member formed in parallel to the ventilation wall so that second one end is connected to the first other end and the second other end is directed to the upstream side of the cooling air, and
the bay portions are formed between the first protruding portion and the ventilation wall, and between the first and second protruding members.

10. The video display device according to claim 1,
wherein the protruding portion includes a first protruding member formed so that first one end is connected to the ventilation wall at an obtuse angle and the first other end is directed to the downstream side of the cooling air and a second protruding member formed not in parallel with the ventilation wall so that second one end is connected to the first other end at an angle larger than a right angle and the second other end is directed to the upstream side of the cooling air, and
the bay portions are formed between the first protruding member and the ventilation wall, and between the first and second protruding members.

11. The video display device according to claim 1,
wherein the protruding portion includes a first protruding member formed so that first one end is connected at right angles to the ventilation wall and the first other end is directed to the downstream side of the cooling air, in which a member surface between one end and the other is formed in a staircase pattern, and a second protruding member formed so that second one end is connected at right angles to the first other end and a member surface between second one end and the second other end is formed in a staircase pattern, and
the bay portions are formed at concave portions in the member surface formed in the staircase pattern.

12. The video display device according to claim 1,
wherein the air cooling fan is an axial-flow fan.

13. A cooling duct to be a ventilation flue of cooling air, comprising:
a protruding portion provided at an outlet end of the cooling air; and
a bay portion as a concave portion formed by the protruding portion, capturing oil mist and dust gathered along a ventilation wall by the cooling air.
